(19) United States
(12) Patent Application Publication
(10) Pub. No.: US 2007/0000728 A1
(43) Pub. Date: Jan. 4, 2007

(54) Multiple path fluid flow architecture for transmission cooling and lubrication

(76) Inventors: Frederic Pignard, Plobsheim (FR); Jean-Daniel Kiefer, Niederhaslach (FR)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/171,644

(22) Filed: Jun. 30, 2005

(51) Int. Cl. F16H 57/04

(52) U.S. Cl. 184/6.12

(57) ABSTRACT

The apparatus of the present invention provides a multiple path fluid flow architecture for cooling and lubricating an automatic transmission. More precisely, the apparatus of the present invention is adapted provide a first flow rate of transmission fluid to meet the transmission cooling requirements, and a second reduced flow rate of transmission fluid adapted to meet the transmission lubrication requirements. In this manner, a high flow rate may be provided to cool the transmission and a reduced flow rate may be provided to lubricate the transmission such that the cooling capacity of the system is increased without reducing the efficiency of the transmission.

### TECHNICAL FIELD

The present invention is drawn to a multiple path fluid flow architecture for cooling and lubricating an automatic transmission.

### BACKGROUND OF THE INVENTION

Transmission fluid is used to lubricate and cool automatic transmissions such as those used in vehicles with internal combustion engines. The increased operating speeds of automatic transmissions causes heat to be absorbed by the transmission fluid which must be removed to obtain the optimum temperature level of both the transmission fluid and the transmission components and to obtain optimum lubrication performance. Typically, an air to oil heat exchanger or an oil to coolant water heat exchanger separate from or integrated in the bottom portion of the vehicle radiator receives a coolant inlet line or conduit from the transmission and has an outlet conduit connected to the transmission to circulate transmission fluid between the transmission and the cooler to remove heat from the lubrication fluid.

In a conventional system, the same transmission fluid flow is implemented for both cooling and lubrication. An increase in the transmission fluid flow rate advantageously provides additional cooling capacity. However, when the transmission fluid is used for lubrication, the increased flow rate increases spin losses thereby reducing transmission efficiency.

### SUMMARY OF THE INVENTION

The apparatus of the present invention provides a multiple path fluid flow architecture for cooling and lubricating an automatic transmission. More precisely, the apparatus of the present invention is adapted provide a first flow rate of transmission fluid to meet the transmission cooling requirements, and a second reduced flow rate of transmission fluid adapted to meet the transmission lubrication requirements. In this manner, a high flow rate may be provided to cool the transmission and a reduced flow rate may be provided to lubricate the transmission such that the cooling capacity of the system is increased without reducing the efficiency of the transmission.

The apparatus of the present invention preferably includes transmission fluid disposed in a sump or reservoir. The transmission fluid is drawn from the reservoir by a pump and transferred into a cooler channel of the transmission. The transmission fluid returned from the vehicle heat exchanger is transferred through the lubrication channel back to the sump. As the transmission fluid flows through the cooler and lubrication channels it absorbs heat to cool the transmission. The transmission fluid therefore becomes hot and is preferably cooled in a heat exchanger. A portion of the transmission fluid exiting the heat exchanger is preferably diverted back to the sump, and the remainder of the transmission fluid exiting the heat exchanger is implemented to lubricate the transmission.

According to a preferred embodiment, a leak orifice and a flow balance orifice are located downstream relative to the vehicle's heat exchanger. The leak orifice and the flow balance orifice are adapted to divert a predetermined amount of the transmission fluid transferred through the vehicle cooling channels. The flow rate of transmission fluid provided to lubricate the transmission may be controlled by varying the size of the leak orifice and the flow balance orifice to meet the needs of a particular transmission.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1a is a schematic illustration of a conventional transmission cooling and lubrication system;

FIG. 1b is flow diagram illustrating fluid flow through the conventional transmission cooling and lubrication system of FIG. 1a;

FIG. 2a is a schematic illustration of a transmission cooling and lubrication system according to the present invention;

FIG. 2b is flow diagram illustrating fluid flow through the transmission cooling and lubrication system of FIG. 2a;

FIG. 3 is schematic illustration of a cooler channel of the transmission cooling and lubrication system of FIG. 2a; and

FIG. 4 is a graph of cooler flow versus line pressure illustrating operational characteristics of the systems shown in FIGS. 1a and 2a.

### DESCRIPTION OF THE PREFERRED EMBODIMENTS

The apparatus of the present invention provides multiple path fluid flow architecture for cooling and lubricating an automatic transmission.

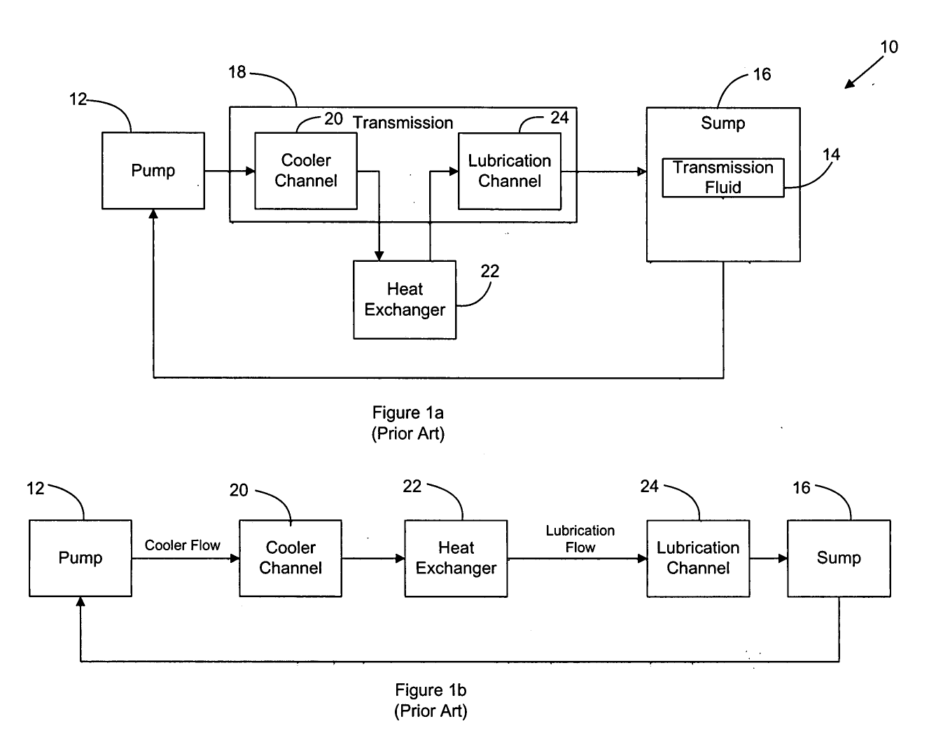

Referring to FIG. 1a, a schematic depiction of a conventional transmission cooling and lubrication system 10 is shown. The transmission cooling and lubrication system 10 implements a pump 12 to draw transmission fluid 14 from a sump or reservoir 16. Although the pump 12 and the sump 16 are shown outside of the transmission 18, one or both of these components may alternatively be disposed within the transmission 18. The transmission fluid 14 is transferred by the pump 12 to a cooler channel 20 of the transmission 18. After absorbing heat from the transmission 18, the transmission fluid 14 flows from the cooler channel 20 to a heat exchanger 22. After the transmission fluid 14 is sufficiently cooled in the heat exchanger 22, the fluid 14 is transferred to a lubrication channel 24 of the transmission 18, and then back to the sump 16.

Referring to FIG. 1b, a flow diagram of the transmission cooling and lubrication system 10 is shown. The transmission fluid transferred from the pump 12 to the cooler channel 20 for cooling the transmission 18 (shown in FIG. 1a) is referred to as “cooler flow”. The transmission fluid transferred from the heat exchanger 22 to the lubrication channel 24 for lubricating the transmission 18 is referred to as “lubrication flow”. As shown in FIG. 1b, for the conventional transmission cooling and lubrication system 10, cooler flow is equal to lubrication flow such that if, for example, the cooler flow is 15 liters/minute, the lubrication flow is also 15 liters/minute.

An increase in the cooler flow provides additional cooling capacity which may be necessary for applications such as, for example, high performance vehicles designed to operate at high speeds. However, an increase in lubrication flow can increase spin losses thereby reducing transmission efficiency. As cooler flow is equal to lubrication flow for the conventional transmission cooling and lubrication system 10, a transmission requiring high cooler flow will also have excessive lubrication flow which causes a reduction in efficiency due to spin loss.

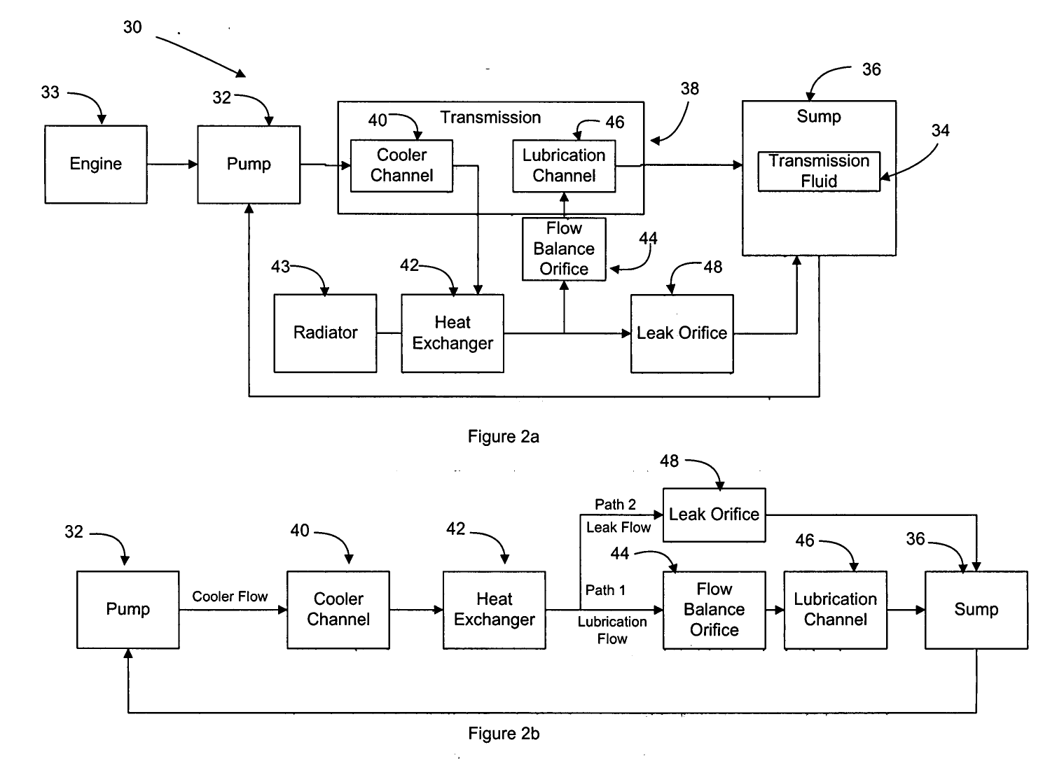

Referring to FIG. 2a, a schematic depiction of a transmission cooling and lubrication system 30 in accordance with the present invention is shown. The transmission cooling and lubrication system 30 implements a pump 32 to draw transmission fluid 34 from a sump or reservoir 36. Although the pump 32 and the sump 36 are shown outside of the transmission 38, it should be appreciated that one or both of these components may be disposed within the transmission 38 according to alternate embodiments of the present invention. The pump 32 may be driven by the vehicle's engine 33 or any other conventional power source. According to a preferred embodiment, the transmission fluid 34 is an oil based fluid; however, other conventional fluids adapted for cooling and/or lubrication may be implemented as well. The transmission fluid 34 is transferred by the pump 32 to a cooler channel 40 of the transmission 38. After absorbing heat from the transmission 38, the transmission fluid 34 flows from the cooler channel 40 to a heat exchanger 42. According to a preferred embodiment, the heat exchanger 42 is an air to oil heat exchanger integrated into the bottom portion of the vehicle's radiator 43; however, other conventional heat exchanger configurations and locations may be envisioned. According to an alternate embodiment, the radiator 43 may be used in place of the heat exchanger 43.

After the transmission fluid 34 is sufficiently cooled in the heat exchanger 42, the fluid 34 follows a first path identified as “path 1”, and a second path identified as “path 2”. A flow balance orifice 44 and a leak orifice 48 each have a predetermined diameter adapted to control the ratio of transmission fluid 34 transferred into path 1 and path 2. The transmission fluid 34 following path 1 goes through the flow balance orifice 44, into a lubrication channel 46 of transmission 38, and then back to the sump 36. The transmission fluid 34 following path 2 goes through the leak orifice 48 and then back to the sump 36.

Referring to FIG. 2b, a flow diagram of the transmission cooling and lubrication system 30 is shown. The transmission fluid transferred from the pump 32 to the cooler channel 40 for cooling the transmission 38 (shown in FIG. 2a) is referred to as “cooler flow”. The transmission fluid transferred from the heat exchanger 42 to the flow balance orifice 44 along path 1 is referred to as “lubrication flow”. The transmission fluid transferred from the heat exchanger 42 to the leak orifice 48 along path 2 is referred to as “leak flow”. As shown in FIG. 2b, for the transmission cooling and lubrication system 30, cooler flow is equal to leak flow plus lubrication flow. According to a preferred embodiment of the present invention the cooler flow is 15 liters/minute, the leak flow is 7 liters/minute, and the lubrication flow is 8 liters/minute. It should be appreciated, however, that the percentage of cooler flow transferred into leak flow and lubrication flow may be calibrated by adjusting the diameters of the flow balance orifice 44 and the leak orifice 48.

Accordingly, the apparatus of FIGS. 2a and 2b is adapted to allow an optimized cooler flow configured to meet the cooling needs of a given transmission, and further allows an optimized lubrication flow that is a calibratable amount less than the cooler flow such that the lubrication needs of the given transmission are met without incurring an unnecessary efficiency reduction due to spin loss. In other words, a high cooler flow may be implemented without incurring excessive spin loss by diverting a portion of the cooler flow such that only a portion of the cooler flow is implemented for lubrication.

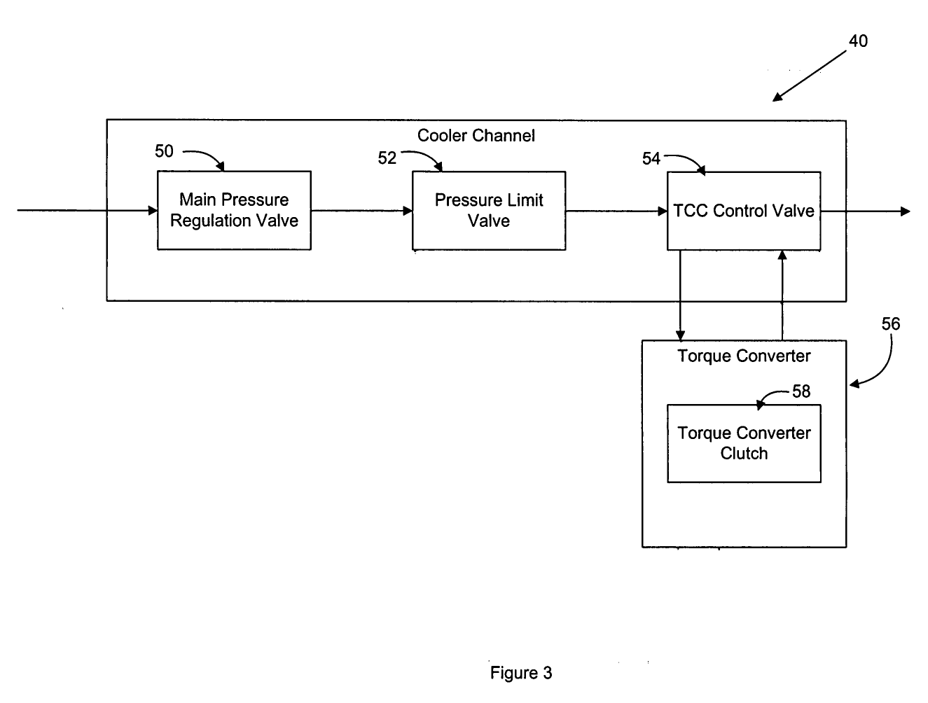

Referring to FIG. 3, the cooler channel 40 (shown in FIGS. 2a and 2b) preferably includes a main pressure regulation valve 50, a pressure limit valve 52 and a torque converter clutch (or TCC) control valve 54. It should be appreciated that while the cooler channel 40 is shown as part of the transmission 38, some or all of the cooler channel components shown in FIG. 3 may be disposed outside the transmission 38 in alternate embodiments.

The main pressure regulation valve 50 regulates the downstream line pressure in the transmission 38 (shown in FIG. 2a). The “line pressure” is defined for purposes of the present invention as the pressure of the transmission fluid 34 (shown in FIG. 2a) transferred through the cooling and lubrication channels (or lines) of the transmission 38. The main pressure regulation valve 50 is adapted to restrict when the line pressure is below a predetermined desired value, and open completely when the predetermined desired line pressure is reached. The pressure limit valve 52 limits the transmission fluid 34 pressure entering the TCC control valve 54. According to a preferred embodiment, the main pressure regulation valve 50 is configured to produce a line pressure within the range of 300 and 2,000 kPa, and the pressure limit valve 52 is configured to produce a line pressure within the range of 300 and 1,000 kPa. The TCC control valve 54 is configured to circulate transmission fluid 34 through a torque converter clutch 58 of a torque converter 56 for the actuation thereof, and further to transmit the transmission fluid 34 to the heat exchanger 42 (shown in FIGS. 2a and 2b). Alternatively, the TCC converter clutch 54 may be configured to transfer transmission fluid 34 directly to the heat exchanger 42 bypassing the torque converter 56.

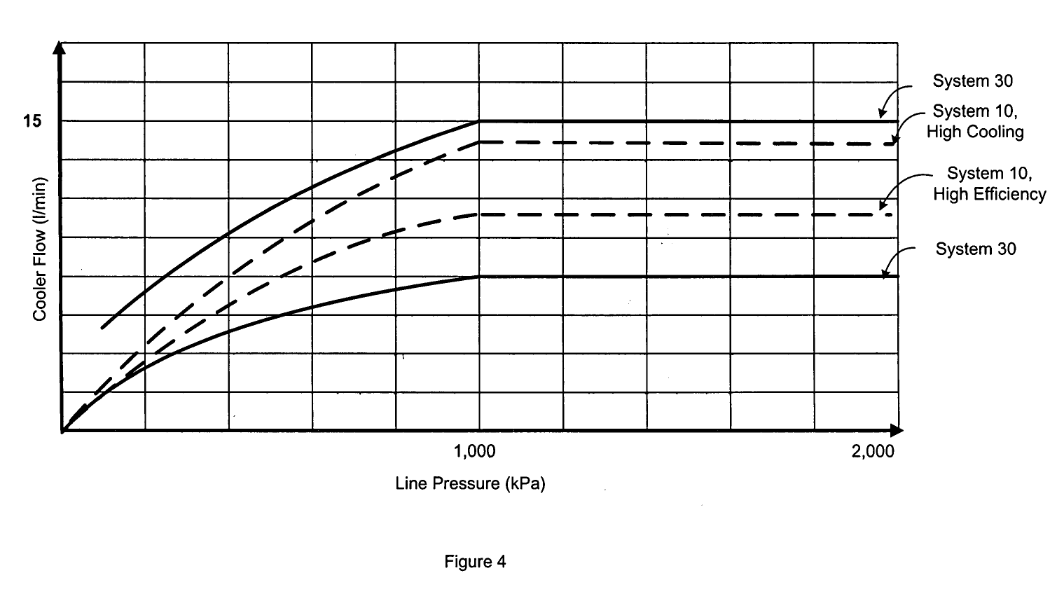

Referring to FIG. 4, a graph of line pressure versus cooler flow illustrating operational characteristics of the transmission cooling and lubrication systems 10 and 30 is shown. The dashed line labeled “system 10, high cooling” represents the conventional cooling and lubrication system 10 with a higher flow rate optimized for cooling capacity. The dashed line labeled “system 10, high efficiency” represents the conventional cooling and lubrication system 10 with a reduced flow rate optimized for transmission efficiency. It should be appreciated that, as described hereinabove, the conventional system 10 can be optimized for cooling or efficiency but not both. In other words, the system 10 optimized for cooling sacrifices efficiency and conversely the system 10 optimized for efficiency sacrifices cooling capacity.

The solid lines labeled “system 30” represent the transmission cooling and lubrication system of the present invention. The system 30 is optimized for both cooling and lubrication in the manner described hereinabove. In other words, as shown in FIG. 4, the system 30 is adapted to provide a higher flow rate for cooling and a reduced flow rate for lubrication such that both cooling capacity and efficiency can be optimized in the same system. It should also be appreciated that the flow rate of the system 30 is slightly greater than the flow rate of the system 10. This is because the implementation of the second path for leak flow reduces back pressure allowing the upstream cooling channel to flow more freely. As the system 30 has an increased flow rate, an increase in cooling capacity is also attainable over the conventional system 10.

While the best mode for carrying out the invention has been described in detail, those familiar with the art to which this invention relates will recognize various alternative designs and embodiments for practicing the invention within the scope of the appended claims.

1. A transmission cooling and lubrication system comprising:
a cooler channel adapted to transmit transmission fluid therethrough such that the heat generated by the transmission during the operation thereof is absorbed by the transmission fluid to cool the transmission;
a first path in fluid communication with said cooler channel wherein said first path is adapted to receive a first portion of the transmission fluid exiting from the cooler channel;
a lubrication channel in fluid communication with said first path wherein said lubrication channel is adapted to receive said first portion of the transmission fluid to lubricate the transmission; and
a second path in fluid communication with said cooler channel wherein said second path is adapted to receive a second portion of the transmission fluid exiting from the cooler channel;
wherein a first flow rate of transmission fluid provided through said cooler channel to cool the transmission is greater than a second flow rate of transmission fluid provided through said lubrication channel to lubricate the transmission such that a cooling capacity of the transmission cooling and lubrication system is increased without reducing the efficiency of the transmission.

2. The transmission cooling and lubrication system of claim 1 further comprising a pump in fluid communication with said cooler channel, said pump being configured to circulate said transmission fluid through the transmission cooling and lubrication system.

3. The transmission cooling and lubrication system of claim 2 further comprising a sump in fluid communication with said pump, said first path, and said second path, said sump being configured to store said transmission fluid.

4. The transmission cooling and lubrication system of claim 3 further comprising a heat exchanger in fluid communication with said cooler channel, said first path, and said second path, said heat exchanger being configured to cool said transmission fluid.

5. The transmission cooling and lubrication system of claim 4 further comprising a leak orifice in fluid communication with said second path and said sump.

6. The transmission cooling and lubrication system of claim 5 further comprising a flow balance orifice in fluid communication with said first path and said lubrication channel, said flow balance orifice being configured to regulate the amount of transmission fluid transferred through the first path and the second path.

7. The transmission cooling and lubrication system of claim 6 wherein the cooler channel includes a main pressure regulation valve in fluid communication with said pump.

8. The transmission cooling and lubrication system of claim 7 wherein the cooler channel includes a pressure limit valve in fluid communication with said main pressure regulation valve.

9. The transmission cooling and lubrication system of claim 8 wherein the cooler channel includes a torque converter clutch control valve in fluid communication with said pressure limit valve.

10. A transmission cooling and lubrication system comprising:
a sump;
a pump adapted to draw transmission fluid from the sump;
a cooler channel in fluid communication with the pump and adapted to receive transmission fluid therefrom such that the heat generated by the transmission during the operation thereof is absorbed by the transmission fluid to cool the transmission;
a heat exchanger in fluid communication with the cooler channel adapted to cool the transmission fluid;
a first path in fluid communication with said heat exchanger wherein said first path is adapted to receive a first portion of the transmission fluid exiting from the heat exchanger;
a lubrication channel in fluid communication with said first path wherein said lubrication channel is adapted to receive said first portion of the transmission fluid to lubricate the transmission; and
a second path in fluid communication with said heat exchanger wherein said second path is adapted to receive a second portion of the transmission fluid exiting from the heat exchanger;
wherein a first flow rate of transmission fluid provided through said cooler channel to cool the transmission is greater than a second flow rate of transmission fluid provided through said lubrication channel to lubricate the transmission such that a cooling capacity of the transmission cooling and lubrication system is increased without reducing the efficiency of the transmission.

11. The transmission cooling and lubrication system of claim 10 further comprising a leak orifice in fluid communication with said second path and said sump.

12. The transmission cooling and lubrication system of claim 11 further comprising a flow balance orifice in fluid communication with said first path and said lubrication channel, said flow balance orifice being configured to regulate the amount of transmission fluid transferred through the first path and the second path.

13. The transmission cooling and lubrication system of claim 12 wherein the cooler channel includes a main pressure regulation valve in fluid communication with said pump.

14. The transmission cooling and lubrication system of claim 13 wherein the cooler channel includes a pressure limit valve in fluid communication with said main pressure regulation valve.

15. The transmission cooling and lubrication system of claim 14 wherein the cooler channel includes a torque converter clutch control valve in fluid communication with said pressure limit valve.

16. A transmission cooling and lubrication system comprising:
a sump;
a pump adapted to draw transmission fluid from the sump;
a cooler channel in fluid communication with the pump and adapted to receive transmission fluid therefrom such that the heat generated by the transmission during the operation thereof is absorbed by the transmission fluid to cool the transmission;
a heat exchanger in fluid communication with the cooler channel adapted to cool the transmission fluid;
a first path in fluid communication with said heat exchanger wherein said first path is adapted to receive a first portion of the transmission fluid exiting from the heat exchanger;
a flow balance orifice in fluid communication with said first path;
a lubrication channel in fluid communication with said flow balance orifice, wherein said lubrication channel is adapted to receive said first portion of the transmission fluid from the heat exchanger to lubricate the transmission;
a second path in fluid communication with said heat exchanger wherein said second path is adapted to receive a second portion of the transmission fluid exiting from the heat exchanger; and
a leak orifice in fluid communication with said second path and said sump;
wherein a first flow rate of transmission fluid provided through said cooler channel to cool the transmission is greater than a second flow rate of transmission fluid provided through said lubrication channel to lubricate the transmission such that a cooling capacity of the transmission cooling and lubrication system is increased without reducing the efficiency of the transmission.

17. The transmission cooling and lubrication system of claim 16 wherein the cooler channel includes a main pressure regulation valve in fluid communication with said pump.

18. The transmission cooling and lubrication system of claim 17 wherein the cooler channel includes a pressure limit valve in fluid communication with said main pressure regulation valve.

19. The transmission cooling and lubrication system of claim 18 wherein the cooler channel includes a torque converter clutch control valve in fluid communication with said pressure limit valve.
